(19) United States
(12) Patent Application Publication
(10) Pub. No.: US 2007/0180488 A1
(43) Pub. Date: Aug. 2, 2007

(54) System and method for processing video content

(75) Inventors: Edward A. Walter, Boerne, TX (US); Larry B. Pearson, San Antonio, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/344,918

(22) Filed: Feb. 1, 2006

(51) Int. Cl. H04N 7/16; H04N 11/00; H04N 7/173; H04N 7/00

(52) U.S. Cl. 725/135; 348/468; 725/133; 725/153

(57) ABSTRACT

In a particular embodiment a system and method for processing a tag carried by a video stream are disclosed. The method includes accessing the tag in the video stream, reading a time stamp associated with the tag and processing the tag based on a time indicated by the time stamp. The system accesses a tag in a video stream, reads a time stamp associated with the tag, and runs a script associated with the tag.

### BACKGROUND OF THE DISCLOSURE

1. Field of the Disclosure

The disclosure relates to processing a video content stream.

2. Description of the Related Art

Video content is typically delivered via a digital communication system including servers, routers and high-speed communication links. Video content is typically provided as a Motion Picture Expert Group (MPEG) data stream to an in-home receiver or Set Top Box (STB). Video content providers have begun inserting additional material into the video streams. Additional material such as uniform resource locators (URLs) and advertisement identifiers can be added to video content to enhance the viewing experience.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals.

FIG. 1 is a schematic diagram depicting of an illustrative embodiment showing a consumer interacting with a set of icons on a video display;

FIG. 2 is a schematic diagram depicting another illustrative embodiment showing a menu for multiple items associated with video content;

FIG. 3 is a schematic diagram depicting another illustrative embodiment showing multiple actions for each item shown in FIG. 2;

FIG. 4 is a schematic diagram depicting another illustrative embodiment showing multiple options for each item shown in FIG. 2;

FIG. 5 is a schematic diagram depicting another illustrative embodiment showing communication between a video service provider, a set top box and the Internet;

FIG. 6 is a schematic diagram depicting another illustrative embodiment showing a time line of actions between an IP Video Content Provider and a Set Top Box;

FIG. 7 is a schematic diagram depicting another illustrative embodiment showing identification of a tag message in a video stream;

FIG. 8 is a schematic diagram depicting another illustrative embodiment showing a rewrite menu message;

FIG. 9 is a schematic diagram depicting another illustrative embodiment showing an icon based menu;

FIG. 10 is a schematic diagram depicting another illustrative embodiment showing a remote control;

FIG. 11 is a schematic diagram of a data structure for storing video embedded tag information;

FIG. 12 is a flow chart of functions performed in an embodiment; and

FIG. 13 is a diagrammatic representation of a machine in the form of a computer system within which a set of instructions, when executed, may cause the machine to perform any one or more of the methodologies of the illustrative embodiment.

### DETAILED DESCRIPTION OF AN ILLUSTRATIVE EMBODIMENT

In view of the above, an illustrative embodiment is presented through one or more of its various aspects to provide one or more advantages, such as those noted below.

While an illustrative embodiment discloses the reception and processing by a set top box (STB) of tags in a video stream from an internet protocol television system (IPTV), it is by example only and not intended to be a limiting embodiment. The disclosure applies to any embodiment, including but not limited to, a STB (regardless of the origin of the video stream) having an IP interface for communicating on a home local area network (LAN) and/or the Internet. The tags may associated with the video and be sent separately from the video and video stream to the STB. In one aspect of a particular embodiment a method is disclosed for processing a tag carried by a video stream in system that includes receiving the video stream at a set top box from a server in the system, accessing the tag carried by the video stream at the set top box, reading a time stamp associated with the tag prior to a time indicated by the time stamp, and running a script associated with the tag prior to the time indicated by the time stamp. In another particular embodiment the method further includes accepting at the STB a user input from a remote control to perform a function associated with the tag and choosing a function to perform based on at least one of the set consisting of an event and a tag context associated with the tag. In another particular embodiment the method further includes at least one of the set consisting of executing code, executing a script, accessing a uniform resource locator and accessing a video segment associated with the tag. In another particular embodiment the method further includes restricting a user access to content based on a parental control indicator. In another particular embodiment the method further includes accessing a parental control rating for the user, comparing the parental control rating for the user to a parental control rating for the content, wherein the content is selected from the set consisting of the script, URL and video segment and denying user access to content when the user parental control rating is less than the parental control rating for the content. In another particular embodiment the method further includes scrolling a displayed list of at least one of the set consisting of icons and tag text associated with the tags.

In another particular embodiment the method further includes storing the video stream in a memory and moving to a portion of the video stream stored in memory associated with a selected tag time stamp. In another particular embodiment the method further includes exporting the tag and tagged data to a processor to display information associated with the tag.

In another particular embodiment a method is disclosed for inserting a tag into a video stream in an IPTV system that includes inserting the tag in a video stream at the processor, inserting a script associated with the tag into the video stream at the processor wherein the tag further includes a time stamp having a time indicated by the time stamp which is prior to a time at which a video segment associated with the tag in the video stream will be displayed, and sending the video stream from the processor to a client.

In another particular embodiment a system for processing a tag associated with a video stream in an IPTV system is disclosed that includes a database in memory for storing the tag associated with the video stream, a set top box (STB) for receiving the video stream from the IPTV system, the STB further includes a processor coupled to the database. The processor coupled to the database further includes a first interface for accessing the tag carried by the video stream, a second interface for reading a time stamp associated with the tag prior to a time indicated by the time stamp, and a third interface for executing a script associated with the tag prior to the time indicated by the time stamp.

In another particular embodiment the processor further includes a fourth interface for accepting a user input from a remote control to the STB to perform a function associated with the tag. In another particular embodiment the processor further includes a fifth interface for scrolling a display on an IPTV display of a list of time stamp ordered tags accessed in the video stream. In another particular embodiment, the system further includes a sixth interface for storing the video stream in memory at the STB and a seventh interface for moving to a portion of the stored video stream at the STB associated with a tag text or icon selected on the IPTV display.

In another particular embodiment a system for inserting a tag into a video stream in an IPTV system is disclosed. The system includes a memory for storing the tag to be carried into a video stream and a server including a processor coupled to the database. The processor further includes a first logic module for accessing the tag in memory, a second logic module for inserting the tag into the video stream and a third logic module for inserting a script associated with the tag into the video stream. In another particular embodiment, the server further includes a fourth logic module for inserting executable code for the tag in the video stream.

In another particular embodiment a data structure is disclosed. The data structure includes a field for storing a tag identifier for a tag carried by a video stream and a field for storing a script associated with the tag. In another particular embodiment of the data structure the field for storing a script further contains a field for storing executable code. In another particular embodiment the data structure further includes a field for storing a time stamp associated with the tag. In another particular embodiment the data structure further includes a field for storing a tag context for the tag. In another particular embodiment the data structure further includes a field for storing at least one of an icon definition and a tag text for the tag.

The STB includes a memory where the STB records video content and tags carried by the video stream from an IPTV system into the STB and/or displayed either in real time or from storage. The recording of the current video content occurs as a sliding time window. If the sliding window is increased to record an entire show or to record for 2 hours, then displaying tagged data, including but not limited to scripts, executable code, tag text or icons associated with the tag are stored. The stored tagged data represents the tag in real-time and/or a historical display and allows for continued interactivity with the tags after the show has completed streaming from the IPTV system. Also a computer program in the STB memory may ask a user if they want to “store” the show they just watched in memory (for some period of time—user configurable). This storage in memory allows continued user interactivity with stored tags and video over a longer period of time. That is, tags and associated tag data including but not limited to tagged data, tag text and icons stored in the data structure are still useful after the video has been viewed, i.e., the show is over. Tags may be available prior to the availability of associated video and these tags may be accessed prior to the availability of associated video.

A user input to the STB controls how tagged data, tag text, and icons associated with tags are displayed. The tag text and tag icons may be displayed in real time and/or in a tag history including but not limited to a list of previously displayed tag text and icons, which can be called up on demand before, during or after the video presentation. For example, a mystery show provider may place tags in a video stream (represented by icons or descriptive tag text) for clues to the mystery in the video data stream. Users can select whether to hide the icons or text for clues until the end of the show, if they choose to solve the mystery on their own without the help of the icons or tag text for clues. Users can also select to display the icons or tag text for clues during the mystery show presentation to aid in solving the mystery. The icons or tag text for clues can indicate that the present video scene from the show is a clue and explain the clue's impact on the mystery solution.

Icons or tag text represent a tag and associated tagged data. The tagged data can include but is not limited to a tag, tag timestamp, video timestamp, URL, executable code, a script, parental control indicators, icon definition, tag text definition and/or STB events with parameters in the form of a tag script. The timestamp includes a stated time that indicates a time that can be assigned by a video content provider or IPTV system server or by an STB upon receipt of a video stream. The time stamp can be used to rewind/fast-forward (jump) to a place in video content stored in STB memory where a corresponding video timestamp time appears. The URL can be used to view web pages or other content (outside of the video feed the icon/content tag). The content may be displayed within a picture in picture (PIP) display, full screen display associated with the STB, or sent to and accessed by an external PC (in this case an STB web server or a file server is provided to deliver the tag or URL to PC). An STB event (referred to hereinafter as “event”) can include mouse-over, on click, after click, appear, disappear, etc. STB events trigger subsequent functions like color, font, and icon image changes. Events can also trigger functions such as ActiveX or JavaScript or java applets or similar type code execution. Executable code can be embedded in the tag, tagged data, or script. A script may include executable code that does not require compiling into object code for execution. A script may also include executable instructions.

Mystery show clues can be inserted into video content as tags and tagged data for clues and embedded in the video feed at points within the video representing clues. The tags for clues represent a trail of intelligent breadcrumbs or clues that allow a user to identify clues and/or explore clues within the context of the story. A viewer might want to view the clues in real-time or go back chronologically in a video segment after viewing the shows (using a history mechanism) to review/explore clues in the stored video stream.

For example, video content for a “home improvement” show may include content tags embedded in the video to explain construction/remodeling steps for review or use of tools or use of materials. In a video storage memory embodiment of the STB, tags allow stored navigation of video content and application structure to be implemented in a broadcast/video environment. Tags, executable code, URLs, tag text, and scripts can be stored separately from the video storage or in the STB memory or video storage or both. Storing the tags and tagged data separately allows longer storage of timestamps and URL information. Storing video tags and tagged data together allows full video interactivity with events tied to the icons. Indices (for example, time stamps) into video content can be stored with the tags for correlation between tags, tagged data, i.e., icons, tag text and video content.

Tags or icons can be available in the video stream prior to availability or display of the associated video or prior to showing of the associated video. Tags are assigned a time stamp associated with a time stamp or start and stop markers for a particular location in the real-time video stream or video buffer containing the stored video stream.

The illustrative embodiment displays a scrolled chronological view of tags, tag text or icons associated with video segment or tagged data. The tagged data is accessed in the video stream and stored in a data structure in memory, as discussed below. Forward/Reverse tagging views provide the ability to move forward or backwards to review or preview tagged data before or after viewing video content associated with the tag. The illustrative embodiment provides the ability to click on historic or future tag to retrieve the data before the video is available. The illustrative embodiment provides a script with the ability to automate access and opening of tagged data before or after a video segment is started. For example, a web site access or a video may have an associated tag, script and tagged data component. An STB computer program provides a “look ahead” function that reads a tag time stamp and executable code, a script or URL for the tag. The script is activated to access a web site executing the script ahead of the time at which a video segment starts. The tag time stamp may indicate a time earlier than the time at which a video segment becomes available. The web site for the URL and/or other tagged data can thus be displayed in a PIP screen immediately after running the script to access the tagged data or content, which may consist of but is not limited to a set of instructions to access a URL. The automated function can be time adjusted (i.e., the function executes or “looks ahead” at time stamps, an allotted time, e.g., 5-10 seconds, before the video actually starts, the tagged data is to be retrieved or the script is to be executed.). The look ahead allows the web site to be accessed ahead of a time when it will be presented to a user and ready for display immediately when the video is shown and an icon or tag text selected by the user.

An account supervisor (e.g., parent) at the client device (STB) can set user access levels by sub account identifiers to enforce parental control (PC) to limit access to incoming video content from the IPTV system and script based internet access to inappropriate subject matter including but not limited to audio, text, web sites and video. Ability to adjust PC access via a setting or a Motion Picture Association of America (MPAA) rating enables appropriate users to access the data associated with a video clip. An illustrative embodiment includes the capability of user-by-user PC settings on the STB. Thus an IPTV account for a user household can be broken up into sub accounts with parents acting as supervisors (account holder) and kids (sub-account holders) being subject to PC user access levels determined by parental control levels set by the parents for each user (sub-account holder). The illustrative embodiment includes, but is not limited to, providing the ability reference the same STB parental control mechanism to control not only video access but also control content filter options to limit access to tagged data based on PC. Content filters block content based on user account PC access levels and PC, whether in the video stream or from tag or icon-based web access. For example, a content filter blocks access to video content or script based access when tagged data shows up and tries to access content with a word that is on a BLACK LIST of prohibited words or having a rating higher than a PC user access level. Tags can contain user access block such as PC ratings (such as MPAA rating M, NC-17, R, PG-13 and G).

The illustrative embodiment includes the ability to notify a supervisory user (e.g., a parent) on another television if a child (identified by sub account) attempts to access unacceptable tagged content. (e.g., a parent is watching TV in bed at night. A child is watching TV in a game room and the child attempts to access unacceptable content on the game room TV. The children's STB in the game room can send a notification through the IPTV system (i.e., back to an IPTV server) and back to parent's STB. In this case the parent's Bedroom TV would get a notification.) The message to the parent's STB can be sent from the children's STB via a wireless communication link or back to an IPTV system server where it is retransmitted to the parent's STB. The illustrative embodiment provides the ability to forward the same kind of notification to an email configured email address or to forward voice message to phone number, etc.

The illustrative embodiment provides the ability to export tags and tagged data to a personal computer or server to enable IPTV integration of tagged data. The illustrative embodiment provides the ability to export a tag log or tag history consisting of but not limited to a list of tags, tag data and tagged data (content) accessed in the video stream or content to an external processor such as a personal computer for processing and screen display. The illustrative embodiment provides the ability to export the tag history or log (tags and associated tagged data extracted from the video stream) to the personal computer to play or access the tags from the personal computer. The illustrative embodiment provides the ability to convert the tag history or log into a HTML or other web executable script for a Web server. The illustrative embodiment provides the ability to create a TAG LOG on the PC or Server and have the STB stream the TAG HISTORY directly to the server for greater storage and presentation to a larger audience. In an alternative embodiment the tags and tagged data are sent in a message separate from the video stream (HTML, etc.) from the IPTV system to the STB and correlated with video via the time stamps.

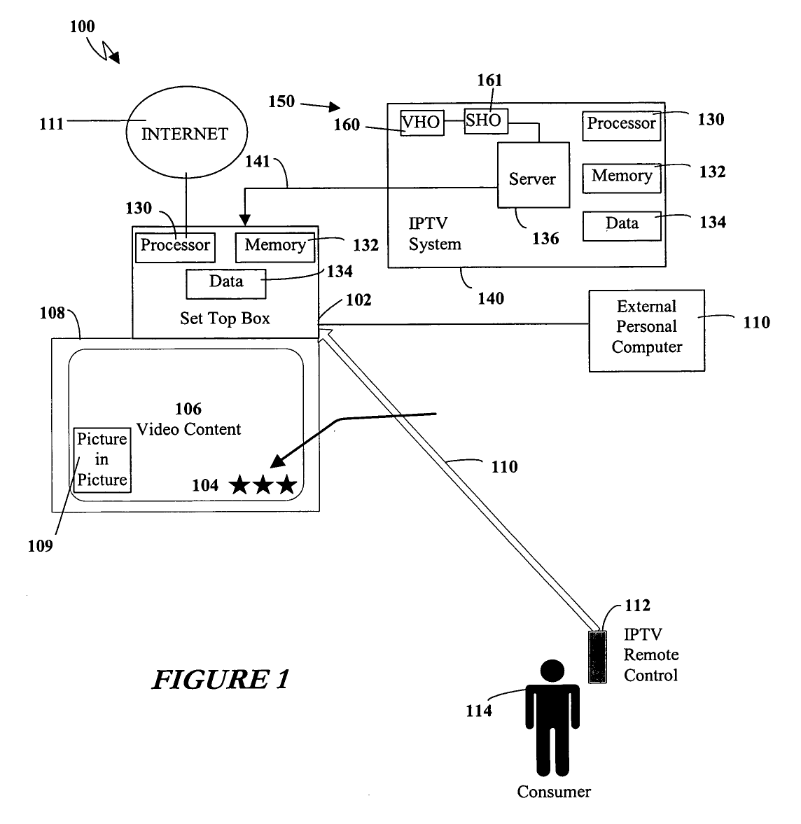

Turning now to FIG. 1, FIG. 1 is a schematic diagram depicting an icon or tag text 104 representing tagged data accessed in a video stream that shows up on the video display screen 106 of an IPTV display 108. The icon or tag text 104 informs the user that there is tagged data, e.g., documents, or information available associated with the current, past, or future time stamped video content shown on video display screen 106. Past, present and future icons can be color coded, e.g., red, green, blue, respectively. A multiplicity of icons (e.g., 100) can be scrolled through chronologically as a display of a subset (e.g., 3) of the multiplicity of past, present and further icons. The system provides interfaces for communication between each of the components including but not limited to STB 102, IPTV system 150, server 136, internet 111, remote control 112, processor 130, memory 132, database 134 and display 108 as shown in FIG. 1.

Video content and embedded tags are received from the IPTV system 150. Video content is sent from a Super head end (SHO) 180 at a national level to regional video head end (VHO) 161. A server 136 associated with SHO or VHO inserts tags and tagged data into the video content. Tags are inserted into the video content by server 136. The server 136 includes but is not limited to a processor 130, memory 132 coupled to processor 130 and database 134 at the server. The memory 132 can include a computer program that is embedded in the memory 132 that can include logic instructions to perform one or more of the method steps described herein. Additionally the database 134 containing the data structure 333 is coupled to the processor 130. STB 102 includes but is not limited to a processor 130, memory 132 coupled to processor 130 and database 134 at the STB. The memory 132 can include a computer program that is embedded in the memory 132 that can include logic instructions to perform one or more of the method steps described herein. Additionally the database 134 containing the data structure 333 wherein tags and tagged data are stored is coupled to the processor 130.

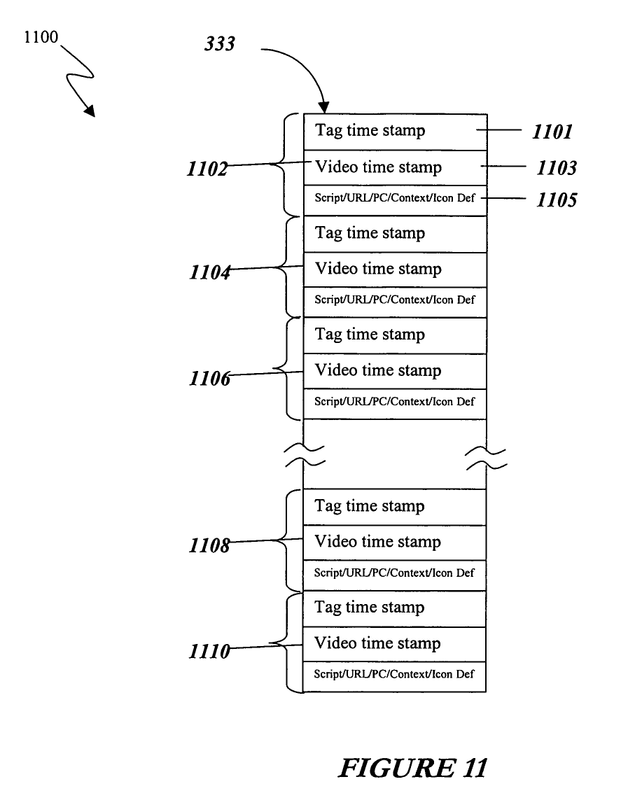

The user 114 accesses the embedded tag and tagged data carried by the video stream by pressing a predefined key on the IPTV remote control 112 to selection icon or tag text associated with a tag. The signal 110 from the IPTV remote control 112 will be transferred to the Set Top Box 102 and will perform a function associated with the icon 104 or text. A function may consist of but is not limited to execution of a script or executable code embedded in or associated with the script for the tag. For example, parental control can be activated when a user clicks on a displayed tag text or icon. The function can be conditioned for performance based on an event (such as selection of the tag text or icon) and the tag state when the event occurs (tag text or icon is selected). A function may be, for example, performance of a script for accessing a URL for a website when the tag text or icon is selected. The function may vary based on a tag context or tag state. The tag state may consist of, but is not limited to, tag text or icon visible (on display), tag text or icon invisible (hidden from display), first display of tag text or icon, subsequent display of tag text or icon, a tag text or icon receives input focus within the display, when tag text or icon loses input focus within the display and when a tag text or icon is activated or clicked on by a user. A tag context may consist of, but is not limited to, a tag state or a variable or field persistently stored in memory and associated with the tag and accessible by the scripts and executable code. The tag context including the tag state and tagged data are stored in the data structure 333 described below in reference to FIG. 11. Thus, the tag context may be checked to choose a script, function or executable code segment to be performed or to choose an entry point into a script or executable code representing different functions or subroutines, based on an event, a tag state or tag context.

The illustrative embodiment provides an event driven programming model which enables the execution of a particular function, script or executable code segment, when a particular event occurs. Events, include but are not limited to user interaction with displayed icons or tag text, such as a change in tag state or a user interaction with an icon or tag text. Events correspond to user input from the remote control to the STB while a user is interacting with the video display which provides a user interface to icons and tag text. The events occur when an icon or descriptive text become visible or invisible (displayed or hidden) on the video display 106 or the user interacts or selects an icon or tag text associated with a tag. For example, when a user using the remote control 112 moves a cursor on the video display 106 over an icon or tag text 104 a “focus” event occurs.

When the user moves the cursor away from the icon or tag text a “defocus” event occurs. The event action can be defined in the tagged data, script or in an icon or tag text definition stored in the data structure 333. Icon definition and tag text definition fields are provided in the data structure to define the icon or tag text and actions to be performed when a user interacts with the defined icon or tag text (i.e., an event occurs). For example, the icon or tag text definition can define the color, shape and appearance of an icon associated with tag, including text or icon to be displayed for the tag, along with functions, actions, scripts, or code segments to be executed when a user operating a remote control provides input to the STB and interacts with the icon or tag text. For example, the icon or tag text definition may specify a function or code segment to be executed when a particular event occurs such as when a user moves to a displayed icon or tag text or places a cursor over an icon or tag text (focus event), moves away from or removes the cursor from the icon or tag text (defocus event) or selects (clicks on) the icon or tag text (select event). A further discussion of the data structure 333 and tagged data stored therein is provided below in reference to FIG. 11.

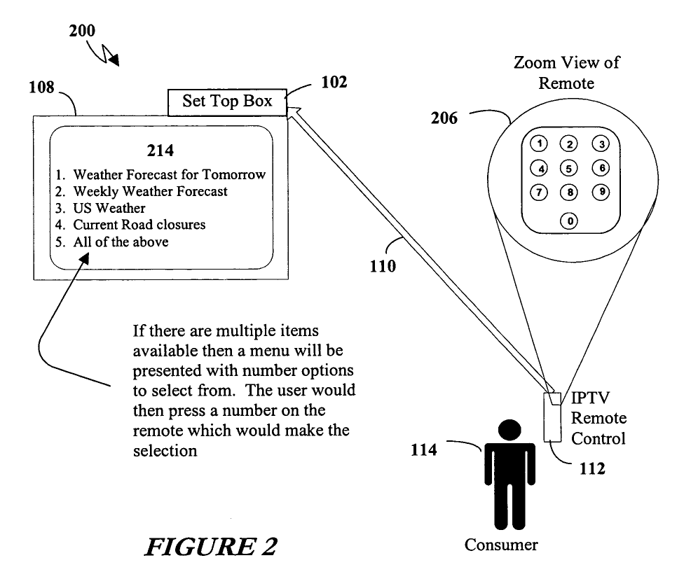

Turning now to FIG. 2, FIG. 2 is an illustrative embodiment of when multiple items such as tag text and icons are available for selection. To keep the selection of content as simple as possible there is a brief description of each subject in menu 214 for the user 114 to select. There are no long URLs or maps to a website but rather a simple description or icon from which the user 114 will select. The consumer 114 would be presented selections as a menu 214 on the IPTV display 108. The user 114 would then select an item or icon via the IPTV remote control 112 a menu option (tag text) via a number key 206 on the IPTV remote control 112. The signal from the IPTV remote control 112 is sent to the Set Top Box 102 through a wired or wireless interface. This event initiates an action such as a script being performed for the underlying associated tag.

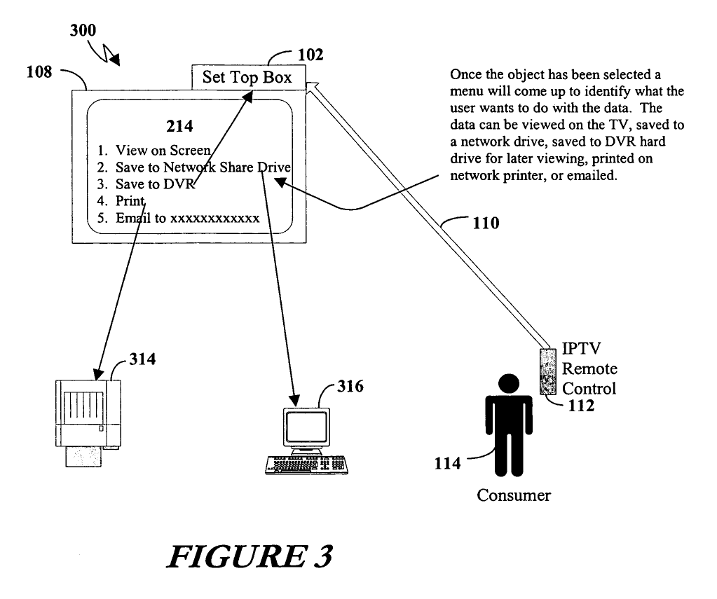

If there is only one option or item available during the selected time interval then the menu would not come up and the object would go directly to the options screen that allows the user 114 to define what they want to do with the selected data. This is depicted in FIG. 3.

Turning now to FIG. 3, FIG. 3 is an illustrative embodiment depicting the options to display selections relating to tagged data or content on the video screen, PIP, email, print, or storage on hard drive for later viewing. The next step of determining where the data, information, or documentation should be routed is provided to the user 114 in a menu 214 on the IPTV display 108. The user 114 would then select an associated number (tag text) on the IPTV remote control 112. The IPTV remote control 112 provides a signal 110 to the STB 102 to cause the processor in the STB to process an appropriate option and perform a function.

Options are not limited to the following but include sending the information to a shared printer resource 314, exported and stored as a file on a shared hard drive 316 on a personal computer, stored as a file on the STB 102 for later viewing, forwarded out as an attachment in an email, or displayed on the IPTV display 108.

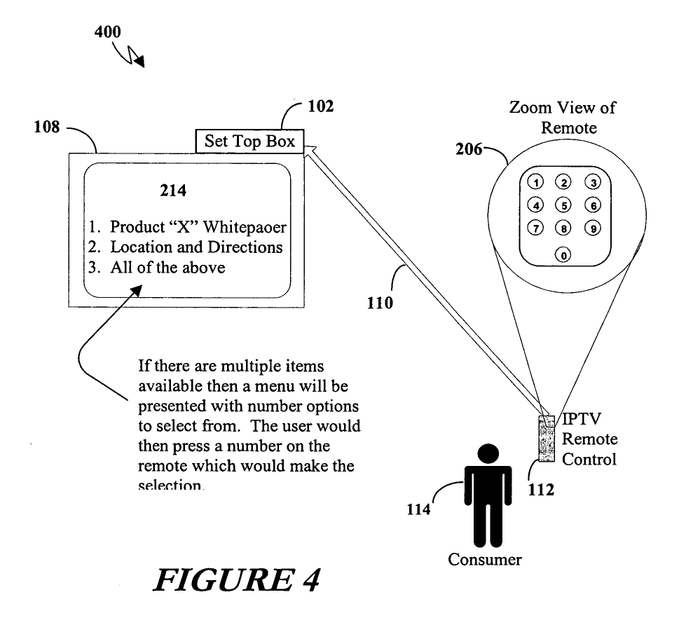

Turning now to FIG. 4, FIG. 4 is an illustrative embodiment, which shows the content type may or may not affect the options. In the case of advertisement, the potential options are not limited to whitepapers, web sites, video or location information but are rather provided here as part of an illustrative embodiment. FIG. 4 demonstrates a menu displayed when multiple tagged data items are available for selection under a tag having advertisement content. To keep the selection of content as simple as possible there is be a brief description presented (tag text) of each tagged data item for the consumer 114 to select from a menu 214. There are no long URLs or maps to a website present but rather a simple description from which the consumer 114 can select. The user 114 would be presented with a menu 214 on the IPTV display 108. The consumer 114 would then select via the IPTV STB remote control 112 a menu option via a number key 206 on the IPTV remote control 112. The signal 110 from the IPTV remote control 112 is presented to the STB 102. This signal 110 causes the STB processor to perform functions, such as execution of a script associated with the underlying associated tag.

The design of the integrated tagged data with video content is done via an IPTV system for a total integrated solution. The video content is delivered from the content provider across the IPTV network, across a high-speed fiber/broadband connection, and through the STB to the IPTV display. During the video content displayed presentation, options to select other text, picture, PIP, or video content that are associated to the video content appear on the screen are provided via tag text, an icon or “indicator” on the screen. When the tag text, icon or indicator is selected a function is performed for the associated tag which is tied to a script or specific URL. The URL points to a document, video, or html page. This URL is hidden and only the menu number (if multiple options) or the “indicator” is shown. In a particular embodiment, selection of icons causes the STB to proceed immediately to a web site. The appearance or style of an icon can indicate the type of access or link action performed when the icon is selected (go directly to URL or to another menu) or type of link data. For example, a square icon can indicate a menu access, a circular icon can indicate a direct web site access, a triangular icon can indicate a mystery clue access, etc.

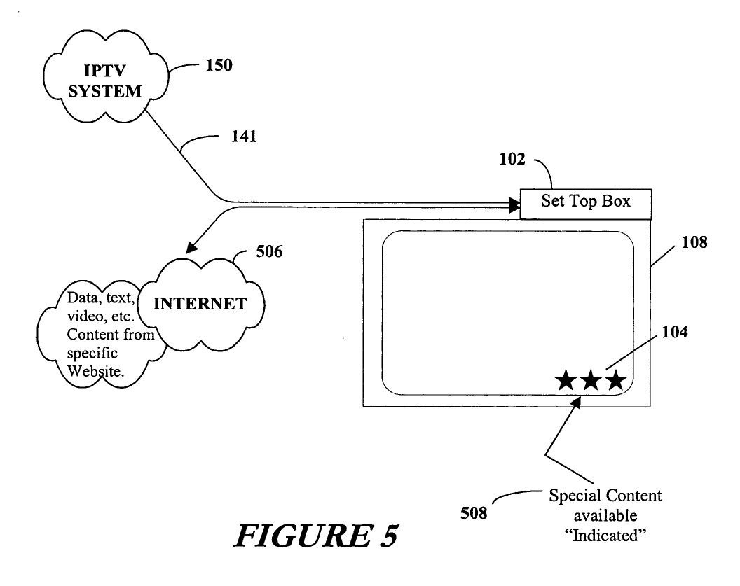

Turning now to FIG. 5, FIG. 5 is an illustrative embodiment depicting a solution design, which provides a communication interface between several components. First, the IP Video Content 141 being presented will be marked with interleaved IP packets containing tags and tagged data that are specifically associated to the content 141 from video service provider 150 being displayed on the IPTV display 108. Thus, RTP packets (video content) will flow from the IPTV system 150 to the STB 102. Video is provided by SHO 160 or the VITO 161. In addition, to the RTP stream, an occasional packet is sent in a message format to either “activate” or “deactivate” the icon 104 indicator on the TV screen and to provide location information about where the associated content is located on a specific website 506 (via URL or IP address). The video content stream may include, but is not limited to, an MPEG-4 part 10 video data stream, which includes time stamp information for associating tags, tagged data, or icons with video content. Analog television signal and tags can be converted into an MPEG-4 part 10 data stream and provided to the STB. The STB can add time stamps to converted analog video content and tags.

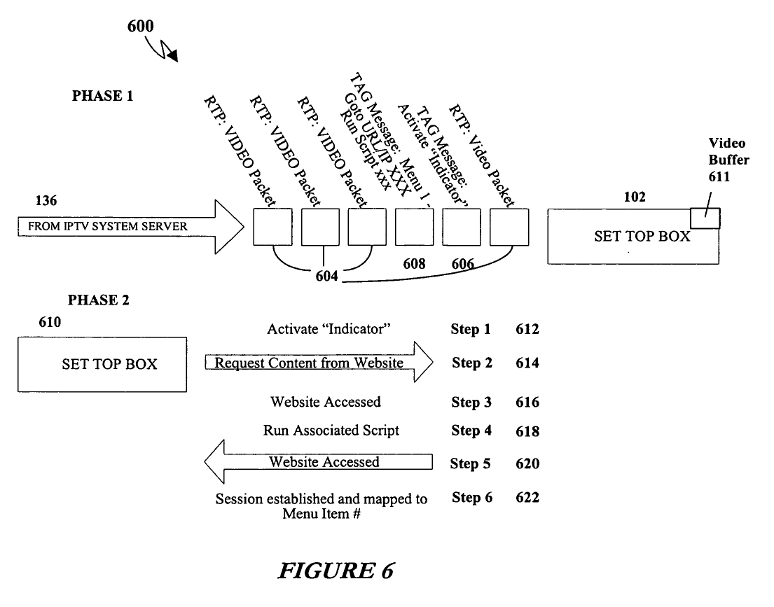

Turning now to FIG. 6, FIG. 6 illustrates a breakdown of the process of a IP Video Content Provider 150 and Set Top Box 102 working in conjunction to provide video content and selected website content to a consumer as an integrated solution in an illustrative embodiment. The Video Content Provider 150 can insert “tags” into video content. Tags may include but are not limited to tag messages, tagged data, URL and script to the IP Video at timed locations. A RTP packet 604 will flow from Video Content Provider 150 to Set Top Box 102 and then onto the IPTV display 108 for display as video. A “Tag Message: Activate” 606 will display the tag or icon to notify the consumer that there is text, document, picture, video, etc. content available and associated with the specific scene current displayed on Video. Tag Messages or tag data will follow 608 that identify tag message information including but not limited to the URL/IP Address, Menu #, tagged data, and script to be run. The tag messages can be stored in STB memory 130 in a data structure 333 shown in FIG. 11. This tag message information is used to locate and prepare to retrieve the targeted information. The script is provided to navigate prompts or website passwords for a specific icon or tag text. The requested data without having to navigate websites manually to access the information. The script allows the data access to be automated.

The STB 102 then activates the “Indicator” 612 (tag text or icon) or performs a function such as running a script associated with the tag and performs the Content Request 614. The initial step with this request is to access the website 616 and run the associated script 618. At this point the website has been fully accessed 620 and a session has been established 622. The content map is stored remotely as a pending request or could be temporarily copied to the Set Top Box 102 as a Temporary File. In either case the data is mapped as a Menu Item 622 or icon that was identified in the TAG Message 608.

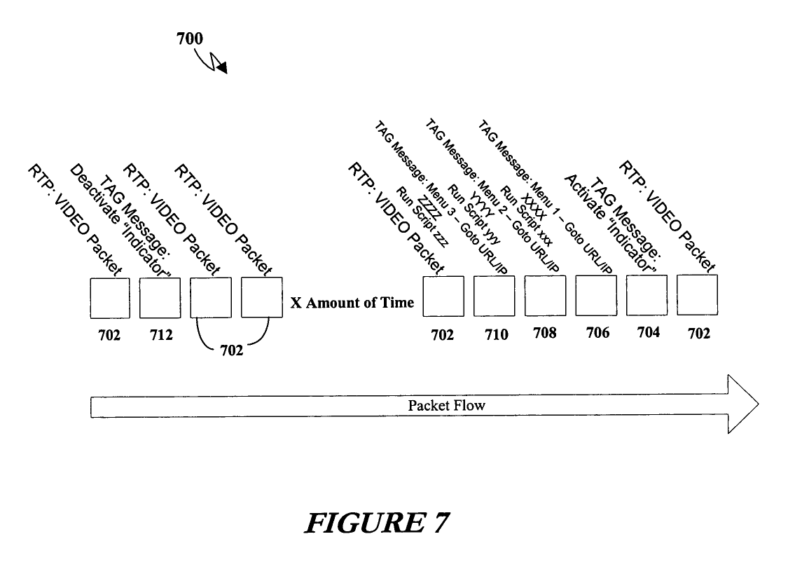

Turning now to FIG. 7, in FIG. 6 the example only identifies one menu item (tag text or icon), however, the TAG Message 608 could have been followed by additional TAG Messages that identified Menu 2 708, Menu 3 710, etc. to be displayed for consumer selection, as in FIG. 7. In addition, the Service Provider could also send a “TAG Message: Deactivate Indicator” 712 that would remove any indication on the TV Display that there is additional viewing content.

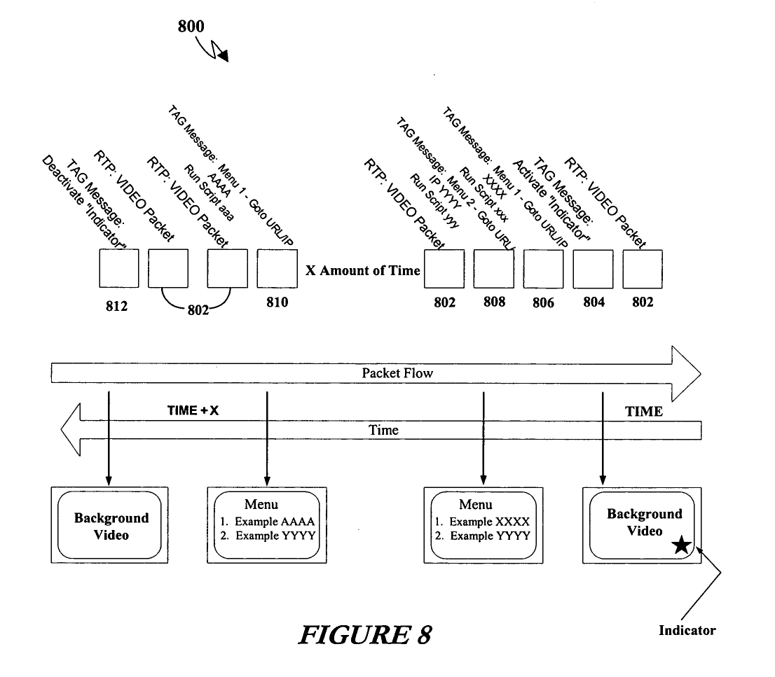

Menu Tag Messages can also be sent to re-write a previous Menu TAG Message. FIG. 8 provides an example of the process. Turning now to FIG. 8, FIG. 8 introduces a re-write menu item feature 810. The stream starts with Standard RTP Video packet 802 and continues with Activate “Indicator” message 804. The stream continues with Menu 1 806, Menu 2 806, Additional RTP packet 802, and then a non-specified amount of time progresses. The stream continues to New Menu 1 message 810 sent to overwrite the original Menu 1 803 message. The stream continues with several more RTP packets 802 and lastly, a Deactivate “Indicator” message 812.

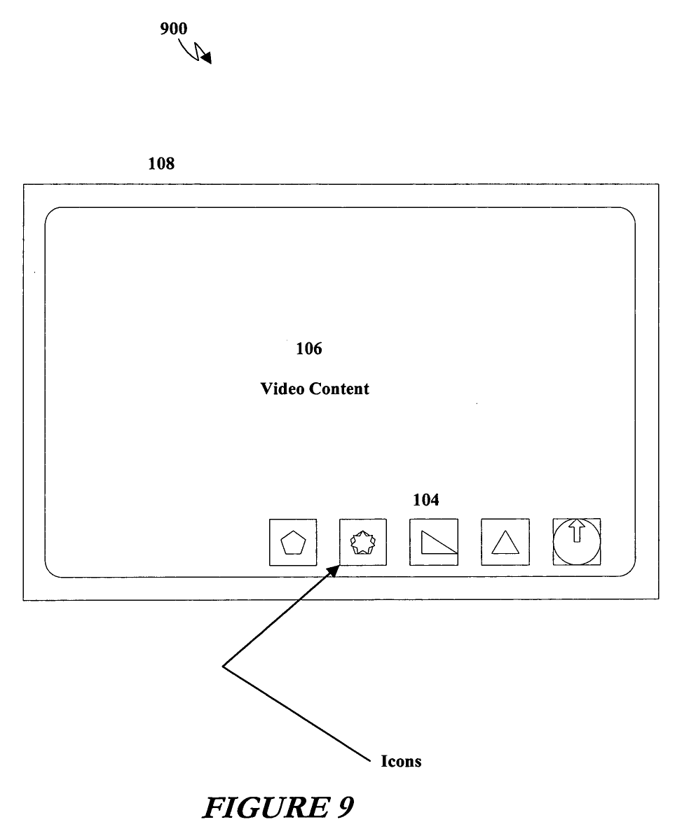

In a particular embodiment an icon-based system rather than a menu-based tag text system is presented. It is straightforward and leverages most of the existing infrastructure above. The difference is instead of a menu number to select from, the remote would be able to scroll through presented icons to select the specific embedded tag data and URL links. FIG. 9 provides additional details.

Turning now to FIG. 9, FIG. 9 presents an illustrative embodiment providing an icon-based solution. The IPTV display 108 displays the Video Content 106. The icons 108 are presented whenever there is tagged data such as URL linked content available. The icons are transparent giving the consumer the ability to continue watching underlying Video Content 106 by having the ability to select linked web-accessible content as well. The icons, like the tag text are associated with the tags and functions that will be executed based on events, scripts and executable code defined and/or stored as the tagged data in the data structure 333.

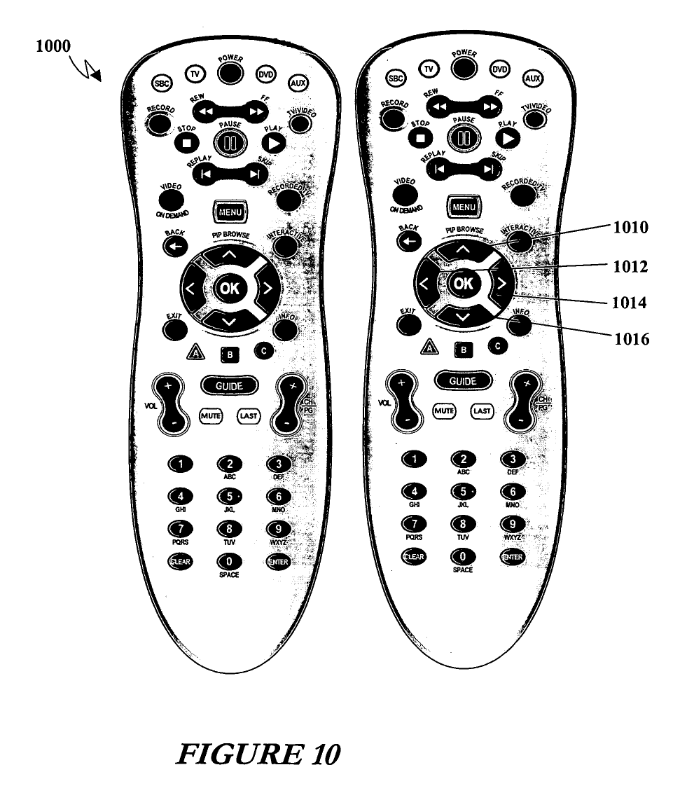

Turning now to FIG. 10, FIG. 10 presents a remote control. For a customer the left (<) 1012, right (>) 1014, up (̂) 1010, and down ( [symbol] ) 1016 arrows on the remote provide the ability to select or move between icons or tag text on the bottom of the screen to select (via the “OK” button) a specific icon or option. This disclosure is not limited to the selection of various icons or text via these keys. Other keys on the remote could potentially be leveraged to select icon or text marked content.

Turning now to FIG. 11, FIG. 11 illustrates a data structure 333 for storing tags and tagged data associated with tags in memory. Each tag is represented by a tag set 1102, 1104, 1106, 1108, and 1110 of tag fields for the tagged data. The tag fields making up each tag set may consist of but are not limited to tag time stamp 1101, video time stamp 1103 and script/URL/Parental Control (PC), icon, icon definition, tag text, tag text definition and tag context including tag state 1105. The tag time stamp can be assigned by the content provider or IPTV server or by the set top box. When the tag time stamp is assigned by the IPTV server, the tag time stamps can be assigned to any time for which a tag is desired to be associated with a particular time in the MPEG-4 part 10 video stream sent from the video server. When assigned by the STB, the time stamp can be read from incoming video content MPEG-4 part 10 stream and duplicated in the tag time stamp. Alternatively, the Set Top Box can assign times to both the video stream and the tag time stamps from a universal clock for IPTV system time. The tag time stamp enables the tag to be associated with a particular time stamped segment in the video buffer or video data stream. When an icon or tag text is selected, an illustrative embodiment refers to the data structure 333 to access an icon definition, tag context and script to determine what action or function to execute. The tag time stamp, video time stamp, PC and URL are used to perform the script or execute the code associated with the tag.

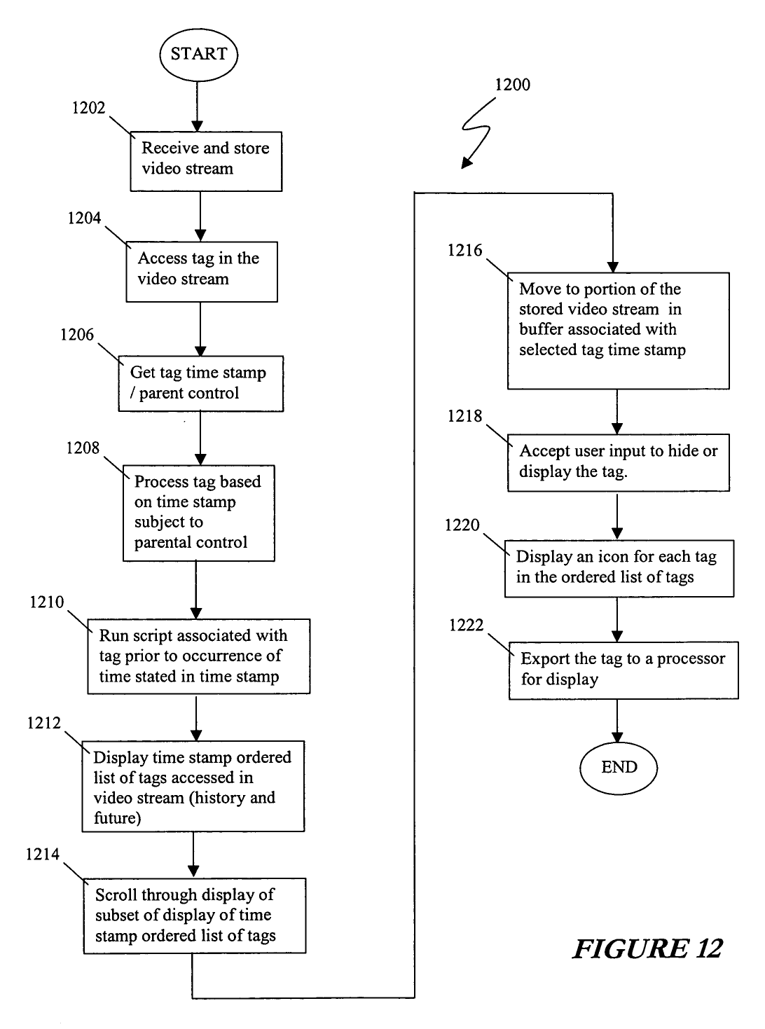

Turning now to FIG. 12, FIG. 12 is a flow chart of functions that may be performed in an illustrative embodiment. In an illustrative embodiment logic modules are provided by the system and method to perform the method. As shown in block 1202 in an embodiment a video stream is received by the STB and stored in memory in the STB. As shown in block 1204 the STB accesses a tag carried in the received video stream. The tags can be accessed in the incoming video stream or in the stored video stream in the memory at the STB. As shown in block 1206 in an embodiment the STB. The tags are processed based on time stamp and are subject to parental control as shown in block 1208. A script associated with the tags can be executed prior to occurrence of time indicated in time stamp as shown in block 1210. The display is time stamp ordered in a list of tags accessed in the video stream including history (time stamp time past) tags and future (time stamp time not yet occurred) tags as shown in block 1212. The system scrolls through a display of a subset of the time stamp ordered list of tags as shown in block 1214. The system then moves to the portion of the stored video stream in the buffer associated with the selected tag time stamp as shown in block 1216. User input from the remote control instructs the STB processor to hide or display the icons or tag text for the tags is accepted as shown in block 1218. Icons or tag text can be displayed for each tag in the ordered list of tags as shown in block 1220. The tags and tagged data (information) are exported to a processor for display or processing as shown in block 1222 and the process ends.

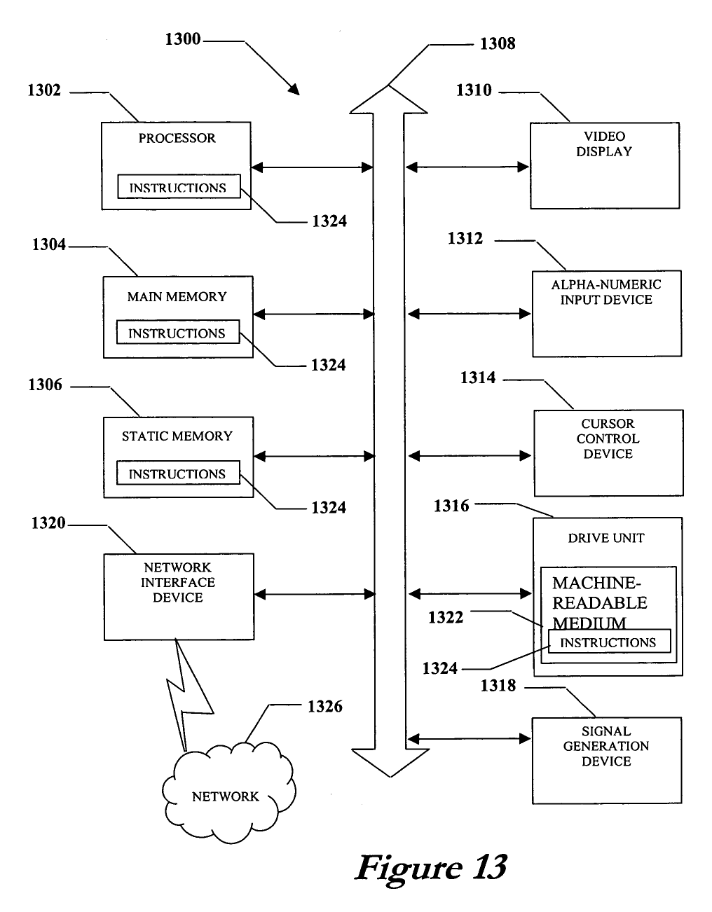

Turning now to FIG. 13, FIG. 13 is a diagrammatic representation of a machine in the form of a computer system 1300 within which a set of instructions, when executed, may cause the machine to perform any of one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the illustrative includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1300 may include a processor 1302 (e.g., a central processing unit (CPU), a graphics processing unit (GPU), or both), a main memory 1304 and a static memory 1306, which communicate with each other via a bus 1308. The computer system 1300 may further include a video display unit 1310 (e.g., a liquid crystal displays (LCD), a flat panel, a solid state display, or a cathode ray tube (CRT)). The computer system 1300 may include an input device 1312 (e.g., a keyboard), a cursor control device 1314 (e.g., a mouse), a disk drive unit 1316, a signal generation device 1318 (e.g., a speaker or remote control) and a network interface device 1320.

The disk drive unit 1316 may include a machine-readable medium 1322 on which is stored one or more sets of instructions (e.g., software 1324) embodying any one or more of the methodologies or functions described herein, including those methods illustrated in herein above. The instructions 1324 may also reside, completely or at least partially, within the main memory 1304, the static memory 1306, and/or within the processor 1302 during execution thereof by the computer system 1300. The main memory 1304 and the processor 1302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 1324, or that which receives and executes instructions 1324 from a propagated signal so that a device connected to a network environment 1326 can send or receive voice, video or data, and to communicate over the network 1326 using the instructions 1324. The instructions 1324 may further be transmitted or received over a network 1326 via the network interface device 1320.

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present illustrative embodiment, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

1. A method for processing tags carried by a video stream, the method comprising:
receiving the video stream at a set top box from a server;
accessing the tag carried by the video stream at the set top box;
reading a time stamp associated with the tag prior to a time indicated by the time stamp; and
running a script associated with the tag prior to the time indicated by the time stamp

2. The method of claim 1, further comprising:
accepting at the STB a user input from a remote control to perform a function associated with the tag; and
choosing a function to perform based on at least one of the set consisting of an event and a tag context associated with the tag.

3. The method of claim 2, wherein the function further comprises:
at least one of the set consisting of executing code, executing a script, accessing a uniform resource locator and accessing a video segment associated with the tag.

4. The method of claim 3, wherein the method further comprises:
restricting a user access to content based on a parental control indicator.

5. The method of claim 4, wherein restricting access further comprises:
accessing a parental control rating for the user;
comparing the parental control rating for the user to a parental control rating for the content, wherein the content is selected from the set consisting of the script, URL and video segment; and
denying user access to content when the user parental control rating is less than the parental control rating for the content.

6. The method of claim 1, wherein the tag further comprises a plurality of tags, the method further comprising:
scrolling a displayed list of at least one of the set consisting of icons and tag text associated with the tags.

7. The method of claim 1, further comprising:
storing the video stream in a memory; and
moving to a portion of the video stream stored in memory associated with a selected tag time stamp.

8. The medium of claim 1, the method further comprising:
exporting the tag and tagged data to a processor to display information associated with the tag.

9. A method for inserting a tag into a video stream in an IPTV system, the method comprising:
inserting the tag in a video stream at the processor;
inserting a script associated with the tag into the video stream at the processor wherein the tag further comprises a time stamp having a time indicated by the time stamp which is prior to a time at which a video segment associated with the tag in the video stream will be displayed; and
sending the video stream from the processor to a client.

10. A system for processing a tag associated with a video stream in an IPTV system, the system comprising:
a database in memory for storing the tag carried by the video stream;
a set top box (STB) for receiving the video stream from the IPTV system, wherein the STB further comprises:
a processor coupled to the database, the processor comprising:
a first interface for accessing the tag associated with the video stream;
a second interface for reading a time stamp associated with the tag prior to a time indicated by the time stamp; and
a third interface for executing a script associated with the tag prior to the time indicated by the time stamp.

11. The system of claim 10, the processor further comprising:
a fourth interface for accepting a user input from a remote control to the STB to perform a function associated with the tag.

12. The system of claim 11, the processor further comprising:
a fifth interface for scrolling a display on an IPTV display of a list of time stamp ordered tags accessed in the video stream.

13. The system of claim 11, the processor further comprising:
a sixth interface for storing the video stream in a memory at the STB; and
a seventh interface for moving to a portion of the stored video stream at the STB associated with a tag text or icon associated with the selected on the IPTV display.

14. A system for inserting a tag into a video stream in an IPTV system, the system comprising:
a memory for storing the tag to be carried into a video stream; and
a server including a processor coupled to the database, the processor comprising:
a first logic module for accessing the tag in memory;
a second logic module for inserting the tag in the video stream; and
a third logic module for inserting a script associated with the tag into the video stream.

15. The system of claim 14, the server further comprising:
a fourth logic module for inserting executable code for the tag into the video stream.

16. A data structure comprising:
a field for storing a tag identifier for a tag carried by a video stream; and
a field for storing a script associated with the tag.

17. The data structure of claim 16, wherein the field for storing the script further comprises a field for storing executable code.

18. The data structure of claim 16, further comprising:
a field for storing a time stamp associated with the tag.

19. The data structure of claim 16 further comprising:
a field for storing a tag context for the tag.

20. The data structure of claim 17 further comprising:
a field for storing at least one of an icon definition and a tag text for the tag.
